(19) United States
(12) Patent Application Publication
(10) Pub. No.: US 2018/0136332 A1
(43) Pub. Date: May 17, 2018

(54) METHOD AND SYSTEM TO ANNOTATE OBJECTS AND DETERMINE DISTANCES TO OBJECTS IN AN IMAGE

(71) Applicant: Wheego Electric Cars, Inc., Atlanta, GA (US)

(72) Inventors: James Ronald Barfield, JR., Atlanta, GA (US); Thomas Steven Taylor, Atlanta, GA (US)

(21) Appl. No.: 15/352,424

(22) Filed: Nov. 15, 2016

(51) Int. Cl. G01S 17/42; G01S 17/89; G01S 17/93; G06K 9/62; G06T 7/00

(52) U.S. Cl. CPC G01S 17/42; G01S 17/89; G06T 7/004; G06K 9/6269; G01S 17/936

(57) ABSTRACT

A controller/application synchronizes a camera's image capture rate with a LIDAR light burst rate and direction. A user may identify and manually bound an object-of-interest in an image captured with the camera with a user interface. Image and LIDAR point cloud data corresponding to the object-of-interest are applied to a machine learning model to train the model to automatically identify and bound objects-of-interest in future images based on point cloud data corresponding to the future images without human intervention. The LIDAR point cloud data and corresponding image data from the automatically identifying and bounding of objects are applied to the trained model to result in a refined trained machine learning model. The refined machine learning model may be used to determine the nature, location, distance, motion, and heading of an object of interest in an image by evaluation of the image without using corresponding LIDAR point cloud data.

### FIELD

Aspects disclosed herein relate to LIDAR and imaging systems, in particular to the use of LIDAR data to train a neural network model for determining the distance to objects detected by an imaging device.

### BACKGROUND

Light-detection and ranging (LIDAR) is an optical remote sensing technology to acquire information of a surrounding environment. Typical operation of the LIDAR system includes illuminating objects in the surrounding environment with light pulses emitted from a light emitter, detecting light scattered by the objects using a light sensor such as photodiode, and determining information about the objects based on the scattered light. The time taken by light pulses to return to the photodiode can be measured, and a distance of the object can then be derived from the measured time.

A Light-detection and ranging (LIDAR) system determines information about an object in a surrounding environment by emitting a light pulse towards the object and detecting the scattered light pulses from the object. A typical LIDAR system includes a light source to emit light as a laser light beam, or laser beam pulses. A LIDAR light source may include a light emitting diodes (LED), a gas laser, a chemical laser, a solid-state laser, or a semiconductor laser diode (“laser diode”), among other possible light types. The light source may include any suitable number of and/or combination of laser devices. For example, the light source may include multiple laser diodes and/or multiple solid-state lasers. The light source may emit light pulses of a particular wavelength, for example, 900 nm and/or in a particular wavelength range. For example, the light source may include at least one laser diode to emit light pulses in a defined wavelength range. Moreover, the light source emits light pulses in a variety of power ranges. However, it will be understood that other light sources can be used, such as those emitting light pulses covering other wavelengths of electromagnetic spectrum and other forms of directional energy.

After exiting the light source, light pulses may be passed through a series of optical elements. These optical elements may shape and/or direct the light pulses. Optical elements may split a light beam into a plurality of light beams, which are directed onto a target object and/or area. Further, the light source may reside in a variety of housings and be attached to a number of different bases, frames, or platforms associated with the LIDAR system, which platforms may include stationary and mobile platforms such as automated systems or vehicles.

A LIDAR system also typically includes one or more light sensors to receive light pulses scattered from one or more objects in an environment that the light beams/pulses were directed toward. The light sensor detects particular wavelengths/frequencies of light, e.g., ultraviolet, visible, and/or infrared. The light sensor detects light pulses at a particular wavelength and/or wavelength range, as used by the light source. The light sensor may be a photodiode, and typically converts light into a current or voltage signal. Light impinging on the sensor causes the sensor to generate charged carriers. When a bias voltage is applied to the light sensor, light pulses drive the voltage beyond a breakdown voltage to set charged carriers free, which creates electrical current that varies according to the amount of light impinging on the sensor. By measuring the electrical current generated by the light sensor, the amount of light impinging on, and thus ‘sensed’, or detected by, the light sensor may be derived.

### SUMMARY

A LIDAR system may include at least one mirror, lens, or combination thereof, for projecting at least one burst of light at a predetermined point, or in a predetermined direction, during a scan period wherein the predetermined point is determined by a controller. A movable LASER array may be used to project light bursts in a plurality of predetermined directions. A camera, in communication with the controller, may capture images at a rate of an adjustable predetermine number of frames per second with each of the predetermined frames corresponding to an open-aperture period during which the camera captures light reflected from a scene it is focused on. The camera may have an adjustable predetermined angular field of view. The LIDAR system and camera may be substantially angularly-synchronized such that the controller directs at least one mirror, lens, combination thereof, or at least one of the LASERS of the array to aim at least one burst of light at a point, or in a direction, within the angular filed of view of the camera and wherein the LIDAR system and camera are substantially time-synchronized such that the controller directs the LIDAR system to emit, or project, the at least one burst of light substantially during an open-aperture period of camera. The controller may manage the angular and temporal synchronization between the LIDAR system and the camera. It will be appreciated that the LIDAR system may be located remotely from a camera that captures an image. If the geographical, or positional, relationship between the LIDAR system and camera are known, a point cloud generated by the LIDAR system in temporal synchronicity with an image captured with a camera may be algorithmically transformed from a coordinate system of the point cloud to a coordinate system of the image. Thus, mathematically transforming a coordinate system of the point cloud to a coordinate system of the image (or to a coordinate system of a camera that captured the image) maps the point cloud to the image.

A controller may be configured for determining object-of-interest pixels lying within an image evaluation range in an image and that represent an object of interest for each of one or more objects of interest. One or more boundaries of an image evaluation range may be generated from manual input from a user, from automatic input based on output from a machine leaning model, such as a neural network, that may have been trained to identify certain classes of objects, or from automatic input based on output of a machine leaning model that may have updated itself to ‘learn’ to identify certain classes of objects as it iterates while processing image information and/or data. A machine leaning model that may generate boundaries that bound an image evaluation range, or that may bound pixels of an object of interest, may be the same machine leaning model used for the generating of labeling of the at least one of the one or more objects of interest. Alternatively, a machine leaning model that may generate boundaries that bound an image evaluation range, or that may bound pixels of an object of interest, may not be the same machine leaning model used for the generating of labeling of the at least one of the one or more objects of interest.

The controller may be configured for generating an image evaluation range data set based on object-of-interest pixels.

The controller may be configured for providing, or causing the applying of, or applying itself, the image evaluation range data set to a machine leaning model, such as a deep learning algorithm, a convolutional neural network, a neural network, support vector machines (“SVM”), regression, or other similar techniques, methods, or functions to train the machine learning model to become a trained machine learning model.

The controller may be further configured for capturing or generating a second image data set based on one or more second images and for applying the second image data set to the trained neural network to determine the nature of, or distance to, one or more objects within the one or more second images.

### BRIEF DESCRIPTION OF THE DRAWINGS

FIG. 1 illustrates an autonomous vehicle in an environment with foreign objects in the road ahead.

FIG. 2 illustrates a sensor pod having a camera and a LIDAR light transmitter/receiver.

FIG. 3 illustrates a flow diagram of a method for applying a point cloud and corresponding images to train a learning model to be used for identifying objects in other images.

FIG. 4 illustrates a flow diagram of a method for applying a trained learning model to images to identify characteristics of, and distances to, objects in the images without using a LIDAR point cloud.

FIG. 5 illustrates a user interface used for manually classifying objects of interest in an image.

FIG. 6 illustrates point cloud data laid over a image showing gradients that indicate distance to surfaces of objects of interest in the image.

FIG. 7 illustrates a method for automatically refining a trained machined learning model.

### DETAILED DESCRIPTION

As a preliminary matter, it will be readily understood by those persons skilled in the art that the present invention is susceptible of broad utility and application. Many methods, aspects, embodiments, and adaptations of the present invention other than those herein described, as well as many variations, modifications, and equivalent arrangements, will be apparent from, or reasonably suggested by, the substance or scope of the described aspects.

Accordingly, while the present invention has been described herein in detail in relation to preferred embodiments and aspects, it is to be understood that this disclosure is only illustrative and exemplary of the present invention and is made merely for the purposes of providing a full and enabling disclosure of the invention. The following disclosure is not intended nor is to be construed to limit the present invention or otherwise exclude any such other embodiments, adaptations, variations, modifications and equivalent arrangements, the present invention being limited only by the claims appended hereto and the equivalents thereof.

Annotation of images typically entails first using a user interface to manually draw boxes, or other shaped boundaries, around objects of interest in an image. LIDAR point cloud data corresponding to objects of interest, or pixels representing them, in the image maybe used to train a machine learning model. The trained machine learning model may then use LIDAR point cloud information corresponding to future images to automatically annotate objects of interest in the future images or to automatically ‘draw’ boundaries around the objects of interest, thus eliminating the need for hand annotation of objects in the future images. Annotated images are used to train convolutional neural networks and other machine learning models to specially classify what an object is and to identify the location of an object in an image, including the location in three-dimensional space based on a two-dimensional image.

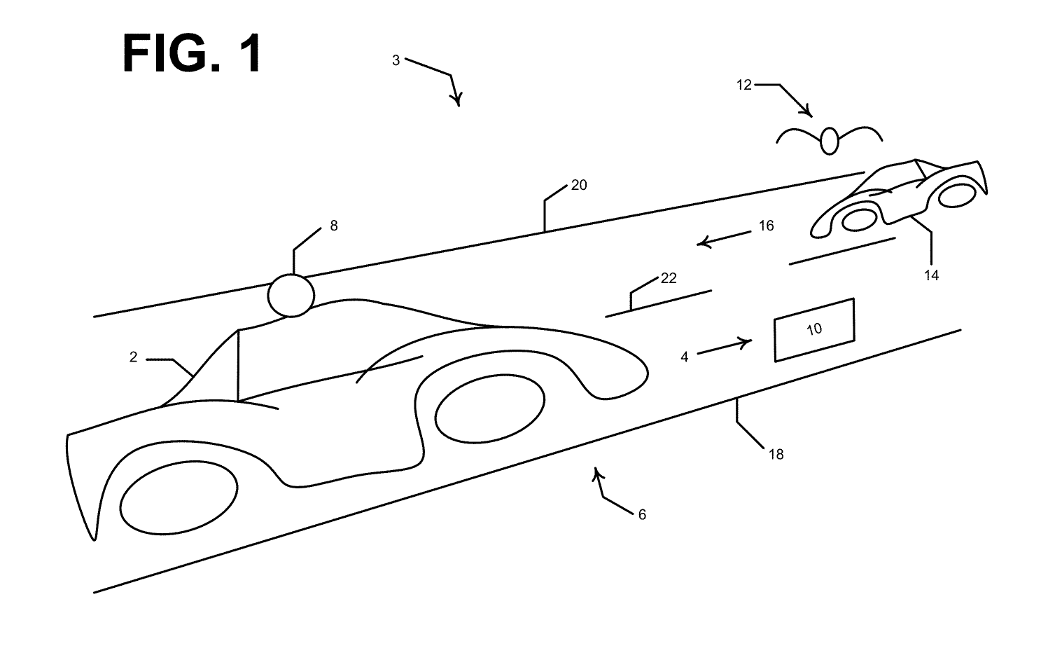

Turning now to the figures, FIG. 1 illustrates a vehicle 2, which may be an autonomous vehicle, traveling in direction 4 in an environment 3 with foreign objects lying in the road 6 ahead. Vehicle 2 includes a sensor pod 8, that may include sensors such as: one or more cameras, some or all of which may be still cameras or video cameras, a LIDAR transmit/receive system, temperature detectors, magnetic detectors for detecting large ferrous object such as another vehicle proximate to vehicle 2, a RADAR system, ultrasound transmit and receive sensors, a microphone, a rain sensor, a barometric pressure sensor, steering angle sensors, acceleration sensors, motor speed sensors, breaking pressures sensors, inertial navigation unit sensors, and other sensors that may be useful when mounted externally to an autonomous vehicle. It will be appreciated that pod 8 is shown in the figure on the roof of vehicle 2 for purposes of clarity, because of the advantage of being above the vehicle to provide 360 degree detection of conditions corresponding to the sensors it contains. However, one or more pods similar to pod 8 could be mounted in front of vehicle 2, on either or both sides of the vehicle, aft of the vehicle, underneath the vehicle, inside the vehicle behind the windshield or wherever else may provide an advantage of increased sensitivity to conditions corresponding to parameters sensors in the pod are configured to detect. In addition, pod 8, or other similar pods, may include all of, or fewer than, the sensors listed, supra. Furthermore, pod 8 may be very streamlined compared to the illustrated pod 8, and may be incorporated into the bodywork of vehicle 2 to improve aesthetics and aerodynamics. In addition, a LIDAR system may not necessarily be collocated with a camera, or other image-capturing device, in a pod of a vehicle. For example, a LIDAR system could be mounted on a roof of a vehicle and a camera could be mounted to the body, chassis, or frame of the vehicle close to the ground or any other location on the vehicle. A point cloud generated by the LIDAR device may be mathematically transformed so that a coordinate system of the point cloud coincides with a coordinate system of one or more image capturing devices regardless of whether they are collocated or located separate from each other. Alternatively, a coordinate system of one or more image capturing devices may be transformed to coincide with a coordinate system of the LIDAR system. For example, a LIDAR system and a camera may be mounted such that they are centered left-to-right with respect to the vehicle, but the LIDAR system may be mounted on the roof of the vehicle such that its sensor center is three feet higher than an axial centerline of the camera as it may be mounted to the vehicle. Thus, the vertical dimension, or ‘z’ dimension, of a LIDAR point cloud may be transformed so that the xy plane of the point cloud is not only parallel with the xy plane of the camera lens, but coplaner with it. This is a simple case where only the z dimension needs transforming to result in the x, y, and x axes of the point cloud being the same as the x, y, and z axes of the camera lens, and an image that it may capture.

As shown in FIG. 1, as vehicle 2 travels in direction 4, it will encounter foreign objects in the road such as item 10, perhaps bird 12, or another vehicle 14. Other vehicle 14 is shown traveling in the opposite direction 16 and in the lane for opposing traffic flow, but the other vehicle could also be in the same lane as autonomous vehicle 2, and could be traveling in the same directing as the autonomous vehicle 2 but at a lower rate of speed. FIG. 1 also shows lane edge markers/stripes 18 and 20, and center lane marker/stripes 22. It will be appreciated that although vehicle 2 is described in reference to FIG. 1 as an autonomous vehicle, the term autonomous vehicle can mean degrees of autonomy that vary across a spectrum that may range between 100% autonomy; where the autonomous vehicle and back end computers that it may communicate with wirelessly via a communication network determine operational parameters such as steering angle, braking force, acceleration force, horn, headlight, windshield wiper, and turn signal operation at one end of the spectrum; and zero percent autonomy, where a driver controls the vehicle, but may rely on warnings generated by the vehicle or backend computers, that are generated based on conditions that may be detected by sensors in pod 8 or, or by sensors that are installed or located elsewhere in the vehicle, such as accelerometers, gyroscopes, pressure sensors, compass, magnetic field detection sensors, microphones, cameras, etc. that may be permanently manufactured as part of the vehicle that are coupled to a communication bus of the vehicle, that may be part of a dongle that plugs into a port that communicates with a communication bus of the vehicle, such as an OBD-II port or similar, or that may be part of a user's device, such as a smart phone, tablet, smart watch, laptop, wearable such as a pendant around the neck or a device clipped on to an article of clothing such as a belt or pocket.

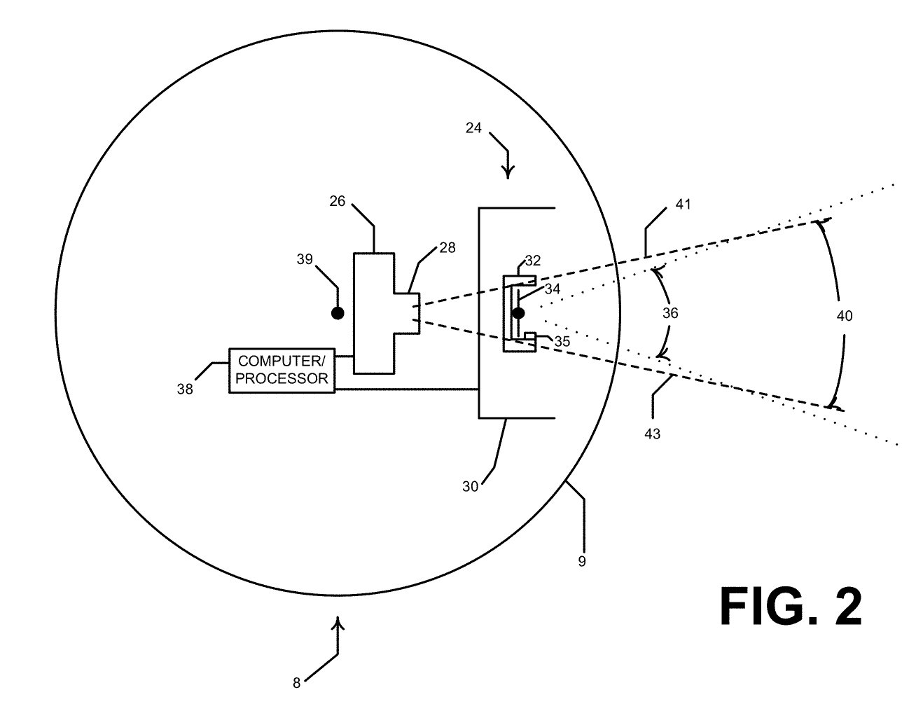

Turning now to FIG. 2, the figure illustrates an aerial view of two sensors in pod 8, LIDAR system 24 and a camera 26, which includes a lens 28. LIDAR system 24 includes a housing 30, and light emitting portion 32. Controllably movable mirror 34 may direct, or projects, bursts of light from a light sources 35 of the LIDAR system in a predetermined direction within arc 36 as determined by controller 38. It will be appreciated that controller 38 may be a microprocessor and supporting circuitry and may be incorporated into pod 8. Controller 38 may include one or more applications running on one or more microprocessors. Alternatively, controller 38 shown in the figure as a box may represent an interface for receiving computer instructions from the vehicle via a wired Controller Area Network (“CAN”), or for receiving instructions via a wireless link, such as a Wi-Fi, or similar, link from an electronic control module of the vehicle, or from a user's device, such as a smart phone, or from other devices as discussed supra.

Regardless of the style, type, or location of controller 38, the controller is coupled to camera 26 and LIDAR system 24, either via wired or wireless link, and may coordinate the orientation or mirror 34, pulse rate of light source 35, and frame rate of the camera. Camera 26 and LIDAR system 24 may be mounted to a frame so that they are continuously rotatable up to 360 degrees about axis 39 of pod 8. In addition, each of camera 26 and LIDAR system 24 may be separately rotatable about axis 39; for example camera 26 could remain focused straight ahead as vehicle travels in direction 4, while LIDAR system rotates about axis 39. Or, camera 26 could rotate while LIDAR system 24 remains pointed ahead in the direction of vehicle travel (or whichever way the sensor pod is oriented as a default, which could be different than direction 4 if the pod is mounted on the sides or rear of the vehicle.

However, a mounting frame may fix camera 26 and LIDAR system 24 so that lens 28 and housing 32 are focused and pointed in vehicle travel direction 4. In such a scenario, controller 38 may control movable mirror 34 so that it has an arc of travel 36 that corresponds to the field of view angle 40 of camera 26, which may vary based on the focal length of lens 28. Lens 28 may be an optically zoomable lens that may be zoomed based on instructions from controller 38. Or, camera 26 may be digitally zoomable, also based on instructions from controller 38. If the focal length of camera 26 increases, field of view angle 40 would typically decrease, and thus controller 28 may correspondingly decrease oscillation arc 36 which mirror 34 may traverse. If the focal length of camera 26 decreases, field of view angle 40 would typically increase, and thus controller 28 may correspondingly increase oscillation arc 36 that mirror 34 may traverse.

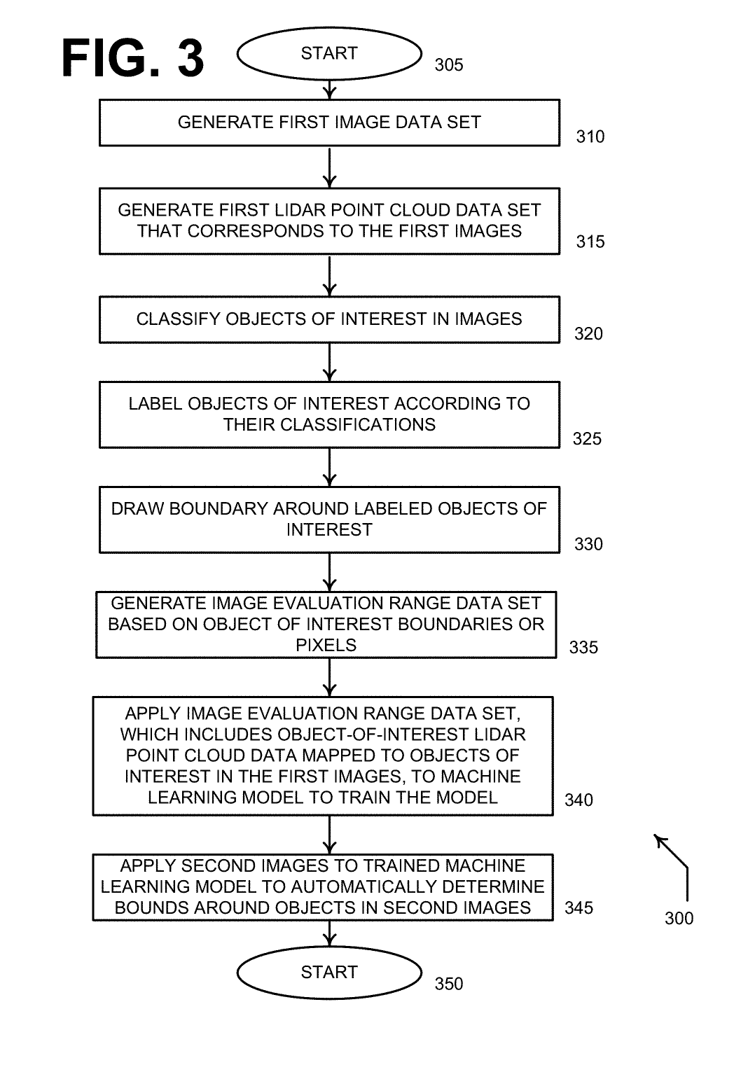

Turning now to FIG. 3, the figure illustrates a flow diagram of a method 300 for applying point cloud data derived from a point cloud and data derived from images corresponding to the point cloud to train a machine learning model to be used for identifying objects in other images. Method 300 begins at step 305. At step 310, a controller captures, causes to be captured, or causes the acquiring of first set of images and generates a first image data set there from. The first image data set may be one or more digital files comprising data that represent or define pixels of the images. The first image data set may be capable of being modified by a user interface application that permits editing of the corresponding image, or images. The interface may also permit a user to create boundaries around one or more objects in the image such that objects, or pixels representing them, in the image may be analyzed by an application such as an image recognition/computer vision application or algorithm. The controller may be a single processor, a discrete processor, a hypervisor, a distributed processor with functions distributed among multiple processors or circuits, a computer device, an application running on a computer device, server, or distributed device, or similar. The controller that causes the acquiring of images may be the same controller, or part of the same device or application as a controller, device, or application that is associated with the user interface. Typically, however, the controller that causes the acquiring of images is a different controller, or part of a different device or application than the controller, device, or application that is associated with the user interface.

At step 315, the controller generates first LIDAR point cloud data that compose a first point cloud data set. LIDAR signals that result in the generating of the point cloud from which the first point cloud data set are derived are generated substantially in temporal synchronicity with the generating of the first images. For example, LIDAR system 24 as shown in FIG. 2 may project a burst of light in a direction with the field of view, and at substantially the same time, that camera 26 captures an image. As vehicle 2 follows a path during a trip in environment 3, LIDAR system 24 and camera 26 capture one or more images and corresponding point clouds that form the bases for the first point cloud data set and the first image data set, respectively. Alternatively, a user could move in an environment holding, directing, or otherwise operating a device that includes a LIDAR system and a camera that are mounted to a common frame, housing, structure, etc., such that the LIDAR system projects light bursts in given directions within the field of view of the camera during a period when the camera is capturing image light from the environment. Alternatively, a remote controlled drone vehicle, such as an airplane drone, a helicopter drone, or an automobile drone, could have the LIDAR and camera systems mounted to them capturing image and point cloud data as the drone vehicles move in an environment.

Continuing with discussion of FIG. 3, at step 320 the controller facilitates classification of objects of interest in the first images. Such classification of objects in the first images may be performed automatically, such as by a computer vision application or system. Or, the classification of objects in the first images may be performed manually via a user interface application by a human user who views the images and uses human judgment to classify the objects into predetermined object classifications. (A user, or computer vision system, may create new classifications if an object doesn't match classification criterion, or criteria, of a preexisting object classification.) For example, a user may identify an object of interest in an image as a pickup truck, and thus classify, or label, the object as belonging to a pickup truck class.

At step 325, the controller or user interface may facilitate labeling the classified objects of interest. In the example of the pickup truck identified in an image, the user interface may provide an input means, such as a dialog box, a dropdown box, a list box, etc., that permits a user to enter the classification label that he, or she, determined as the classification to associate with the pickup truck in the image. The controller may then associate the classification with pixels that correspond to the pickup truck in the image. At step 330, the user interface may facilitate a user ‘drawing’ a rectangular box, or an outline having another shape, around the object of interest in the image (i.e., the pickup truck in the example), which the user interface may translate into a boundary around the pixels corresponding to the pickup truck. It will be appreciated that a computer vision application may also aid in performing, or totally perform, the steps of classifying, labeling, and generating a boundary around the object, or pixels corresponding to the object, or objects, in an image.

The classification and corresponding label, the pixels of the object of interest, and the boundary, or boundary coordinates (e.g., pixels that lie outside the pixels that compose the object of interest and that describe a boundary that surrounds the object pixels) that bound the object pixels may be stored as an image evaluation range data set at step 335. The image evaluation range data set may also include corresponding point cloud data. A controller that controls the LIDAR system and camera may also perform the classifying, labeling, bounding, and generating of the image evaluation rage data set at steps 320-335. Or, a separate controller/application running on a device not coupled with the LIDAR system and camera may receive the first image and first point cloud data sets and perform steps 320-335.

At step 340, a controller, perhaps the same one that performs steps 320-335, or perhaps a controller that is not the controller that performs steps 320-335, applies the image evaluation range data set to a machine learning model. The machine learning model may evaluate the pixels of a given labeled object of interest with a computer vision application and the machine learning model may evaluate point cloud data that corresponds to the labeled object to determine one or more relationships between the point cloud data and the corresponding object of interest pixels. The machine learning model may be initialized based on a manual classification of a given object to facilitate determining the one or more relationships between the point cloud data and the corresponding object of interest pixels. The determining of relationships between the point cloud data and the corresponding object of interest pixels may ‘train’ the machine learning model to become a trained machine learning model.

An example of the relationships that may be determined between the point cloud data and the corresponding object of interest pixels may include distance to the object and a corresponding number of pixels in the image used to represent the object. Other relationships may include angle, direction, or bearing of the object relative to the direction of the camera lens that captured the image that contains the object of interest. For example, if the object of interest is classified as a pickup truck, if the pixels that represent the pickup truck in the image lie in the center of the image, if the light burst was projected in a direction that is in the center of the field of view of the camera when it captured the image that contains the pickup, and if the LIDAR point cloud data indicates that the distance from the LIDAR system to the object (i.e., the pickup truck) is 100 feet, then a relationship between the bounded pixels in the image of the point of interest and the point cloud data may be established and updated by functions of the trained machine learning model.

At step 345, second images subsequently acquired by a camera (either the same or different camera than the one that captured the first images), along with corresponding second LIDAR point cloud data acquired substantially in temporal and directional synchronicity with the acquisition of the second images, are applied to the trained machine learning model to automatically annotate, or select boundaries around, objects of interest in the second images. The machine learning model which may have been trained at steps 315-330 by manually drawing boundaries around an object of interest and by manually designating a classification of the object bounded, may now use its previous training to automatically recognize objects of interest in a second set of images and classify the objects based on the LIDAR point cloud information that corresponds to the second images without human intervention in manually drawing bounds around objects of interest, or without human intervention in classifying objects of interest that the now refined trained machine learning model has identified. Method 300 ends at step 350.

Turning now to FIG. 4, method 400 illustrates a method for identifying, characterizing, and estimating the distance to objects in an image without using point cloud data. It will be appreciated that steps 410-430 are similar to steps 310-345 described in reference to FIG. 3.

Method 400 begins at step 405. At step 410 a first set of images are captured along with a first set of LIDAR point cloud data. The first images and first point cloud data are substantially captured in temporal synchronicity and substantially in directional alignment such that point cloud information in the point cloud data may be mapped to pixels that represent objects in the images. At step 415, a user manually applies boundaries around objects of interest in the first images. A user also classifies the bounded objects in the first images at step 415.

At step 420, the images, corresponding point cloud data, and boundary information are applied to a machine learning model that becomes manually trained (i.e., the object of interest boundaries and classifications thereof were manually input by a user) to recognize relationships between objects in the images, and the classification thereof, and corresponding information from the point cloud data, such as distance, surface contours, surface size, etc. Thus, after the machine learning model becomes a manually trained machine learning model (manually trained in the sense that manually drawn boundaries and manually labeled classification were generated for the first image data set), the manually trained machine learning model may recognize objects in images based on LIDAR point cloud information that corresponds to object pixels in images captured in the future.

At step 425, a second set of images is captured, along with corresponding LIDAR point cloud data that is acquired in temporal synchronicity and directional alignment with the second image set. At step 430 the second images and corresponding point cloud data are applied to the manually trained machine learning model. Now, at step 430, instead of a user manually drawing boundaries around objects of interest and manually classifying identified objects of interest as described in reference to step 415, the manually trained machine learning model may automatically recognize objects of interest based on point cloud data that corresponds to the second images (i.e., images captured in the future relative to the training of the machine learning model) and based on the manual classification information and the training of the machine learning model that resulted in the machine learning model become a trained machine learning model. The automatically recognized objects and classifications thereof, along with characteristics such as distance to the objects in the images, may be applied to the manually trained machine learning model to transform the manually trained machine learning model into an automatically trained first machine learning model (which may be referred to herein as a refined trained machine learning model) at step 435. At step 440, third images, which may be captured without corresponding LIDAR point cloud data, may be applied to the automatically trained machine learning model to determine the nature of, characteristics of, and distances to, objects in the third images. Thus, only image data from an inexpensive camera (inexpensive relative to the cost of a LIDAR system) may be applied to the refined trained machine learning model to determine the distance to objects in the third images without using LIDAR data. Method 400 ends at step 445.

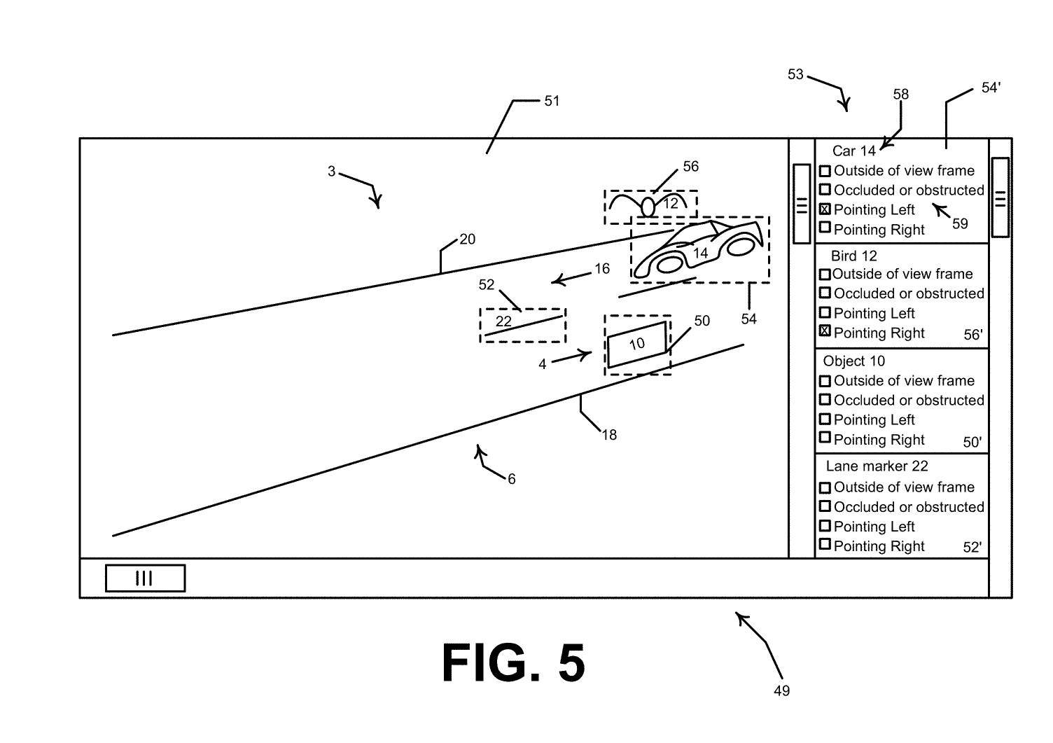

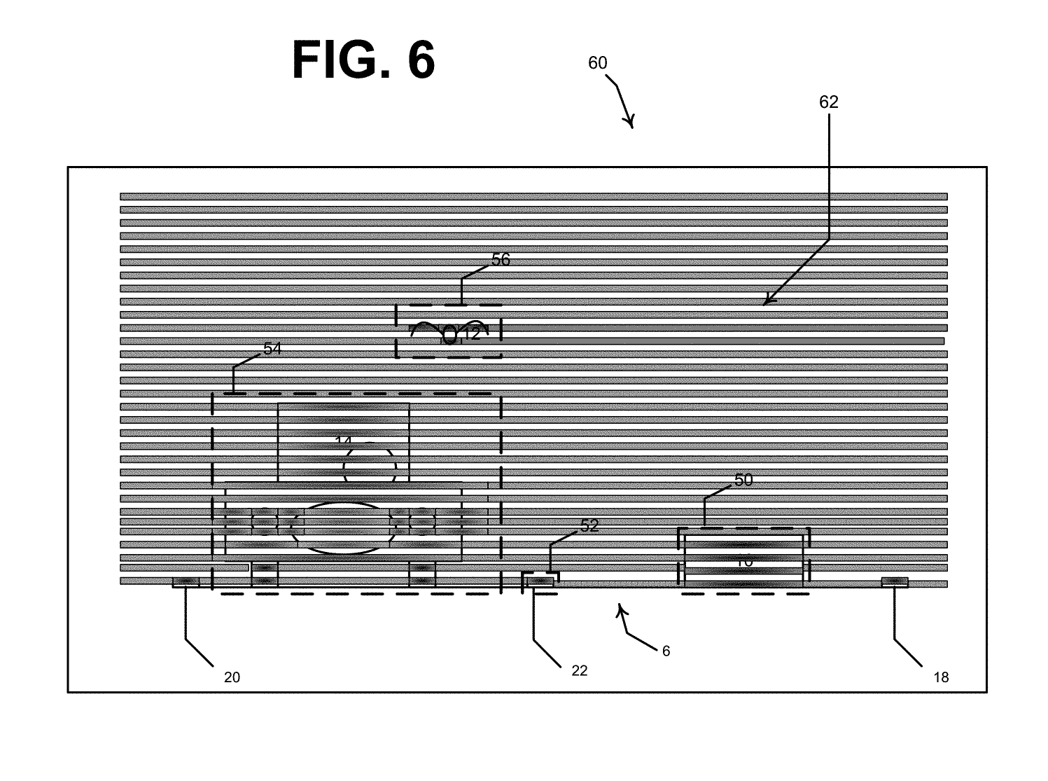

Turning now to FIG. 5, the figure illustrates a user interface 49. Interface 49 is shown displaying environment 3 as shown in FIG. 1, but without vehicle 2. An image of environment 3 is shown in image display pane 51 in the same perspective as shown in FIG, however it will be appreciated that for purposes of discussion the objects shown in the image shown in image display pane 51 are assumed to have been taken with a camera attached to vehicle 2 as shown in FIG. 1. A straight-on view of environment 3 will be shown and described in connection with FIG. 6.

Continuing with description of FIG. 5, interface 49 includes a user input pane 53 which provides input segments for providing description of objects that may be manually selected by a user by drawing boundaries around objects in an image displayed in display pane 51. Input segment 54′ corresponds to the boundary manually drawn around vehicle 14, and provides for inputting information into a database that corresponds to the image displayed in image display pane 51. Input segment 54′ shows a object classification 58 of “Car 14”, and characteristics inputs 59 provide for manually characterizing the corresponding object, in this case vehicle 14. Object input segments 50′, 52′, and 56′ correspond to bounds manually drawn around objects object 10, lane divider marker 22, and bird 12, respectively. Object input segments 50′, 52′, and 56′ include classification descriptions and characteristics inputs that provide similar utility as classification description 58 and characteristics inputs 59 provide relative to the boundary manually drawn around vehicle 14, which is classified as a car. It will be appreciated that FIG. 5 shows as part of the classification description in the object input segments the corresponding item reference number used herein in reference to various figures that would not typically be used as a classification description in practice. Rather, classification may be generic descriptions such as, for example, car, motorcycle, van, semi-truck, pick-up truck, bird, tire, box, guardrail, boat, lane marker, traffic control sign, traffic control light, curb, lane-marking reflector, human, deer, etc.

Users may manually bound objects of interest when viewing a given image captured during an image-capturing session wherein a vehicle takes drives and captures images and LIDAR point clouds substantially temporally synchronized with the capturing of images. When bounds are drawn around objects of interest, and classified and characterized by user inputs in input segments, interface 49 generates data that may be considered as meta data associated with the image which contains the objects around which the bounds are drawn. The meta data correspond to the one or more objects that may be bounded by the manually drawn boundaries, and may include information such as whether the bounded object of interest lies outside of the view frame, or pane 51, either partially and if so the percent outside of the view frame, the orientation of the object, the perceived (by the user of the user interface) heading of the object, perceived (by the user) velocity of the object, whether the object is partially occluded or obstructed, and the percentage to which it is occluded or obstructed, generic description of the object such as pickup truck, or more specific description of the object such as material (such as rubber of the object is a tire) year, make, and model if the object is a vehicle, nature of a traffic sign and message thereon, etc. Thus, the meta data may be provided as inputs, along with LIDAR point clout data and LIDAR point cloud meta data, to a machine learning model that learns how LIDAR point cloud data correlates to image pixels and meta data for a corresponding bounded image object. As more and more bounded image objects from more and more images and corresponding LIDAR point cloud data are provided to a machine learning model, training of the machine learning model improves such that the trained machine learning model, or refined trained machine learning model, can eventually analyze an image and corresponding point cloud data and automatically ‘draw’ boundaries around objects of interest that can then be used with corresponding LIDAR point cloud data to further train, and refine the training of, the machine learning model.

To facilitate training, a LIDAR point cloud may be transformed from a data set representing a three-dimensional space into a data set representing a two-dimensional space. The two-dimensional data-set space may be mapped to an image to which it corresponds to create an image/point-cloud pairing such that point cloud data may be linked as corresponding to objects of interest that have been manually bounded in the image. When data of the image/point-cloud pairing are applied as inputs to a machine learning model, the machine learning model may become trained to ‘recognize’ objects of interest automatically in another image based on a pairing with a point cloud data set that corresponds to the other image.

FIG. 6 illustrates point cloud data laid over an image 60 of environment 3 showing gradient lines 62 that indicate distance to surfaces of objects of interest in the image. In the figure, image 60 shows an elevation view of the objects of environment 3 that are shown in in FIG. 1 from the perspective of an observer viewing the environment, including vehicle 2, from the road side, wherein in FIG. 6 some of the objects from environment 3 in FIG. 1 are shown from the perspective that a camera in pod 8 on vehicle 2 may have captured them. Boundary boxes 50, 52, 54, and 56 are shown drawn around object 10, lane marker paint 22, vehicle 14, and bird 12, respectively. The gradient lines 62 that lie over the background in the image are shown in even grey shading. However, portions of gradient lines 62 that lie over the objects are shown with varying degrees of shading that vary according to the distance from the LIDAR system that captured the point cloud data that the gradient lines represent to the front surface (as ‘seen’ from the LIDAR system) of the object that caused light bursts from the LIDAR system to reflect back to the LIDAR system.

For example, the shading varies in the gradient lines that lie over the windshield portion of the image of vehicle 14, indicating that the windshield has a curvature. Similarly, the gradient lines that lie over the nose of vehicle 14 are generally darker than the lines over the windshield, thus indicating that the nose is closer than the windshield. Furthermore, the shading of gradient lines 62 that lie over the grill and headlights of vehicle 14 vary over those portions of the image, thus indicating that the point cloud data has captured variances in the surface contours of the grill opening and headlight surfaces of the vehicle. Similarly, the gradient lines 62 that lie over object 10 show a variation, with the center of the object being closer that the edges, which may be consistent with light burst reflections from a tire lying in the right lane of road 6. Lane markers 18, 20, and 22 are shown with varying gradient lines, which may indicate that the paint stripe cross section may be crown-shaped rather than perfectly rectangular (i.e., a given stripe paint is thicker at its middle than at its edges).

Gradient lines 62 are shown in FIG. 6 to visually represent a point cloud data set that may have been converted, or transformed, from a three dimensional space to a two-dimensional space, (the transforming may be performed by a filtering process) which may facilitate comparison and mathematical evaluation thereof in conjunction with mathematical evaluation of the data representing the image and objects therein by a machine learning model. Since an image is a two-dimensional data set (i.e., pixels) and the point cloud data set, which a LIDAR system generates as a three-dimensional space, has been transformed into a two-dimensional space, the machine leaning model that evaluates an image sent and a point-cloud set together when they mapped to each other can be trained to automatically identify the nature of, characteristics of, and distance to, objects in future images that have two-dimensional point cloud data sets mapped to them without the step of manually bounding objects of interest by a human. The machine learning model may process the two-dimensional point cloud data set and corresponding image data set (pixel data) by taking into account changes in distances, reflectivity of the LIDAR points and the amount of points in a location (i.e., darker shading in gradients 62 indicate closer object surfaces because the reflected light received at the LIDAR system is typically stronger than when a surface is farther away form the LIDAR light burst source).

Thus, after initial manual classifications of objects in images, and processing them along with corresponding point-cloud data sets that have been transformed into two-dimensional space, a trained machine learning model can quickly refine the classification of objects to increase the accuracy of the trained machine leaning model (which may be referred to herein as a refined trained machine learning model) without time-consuming human intervention.

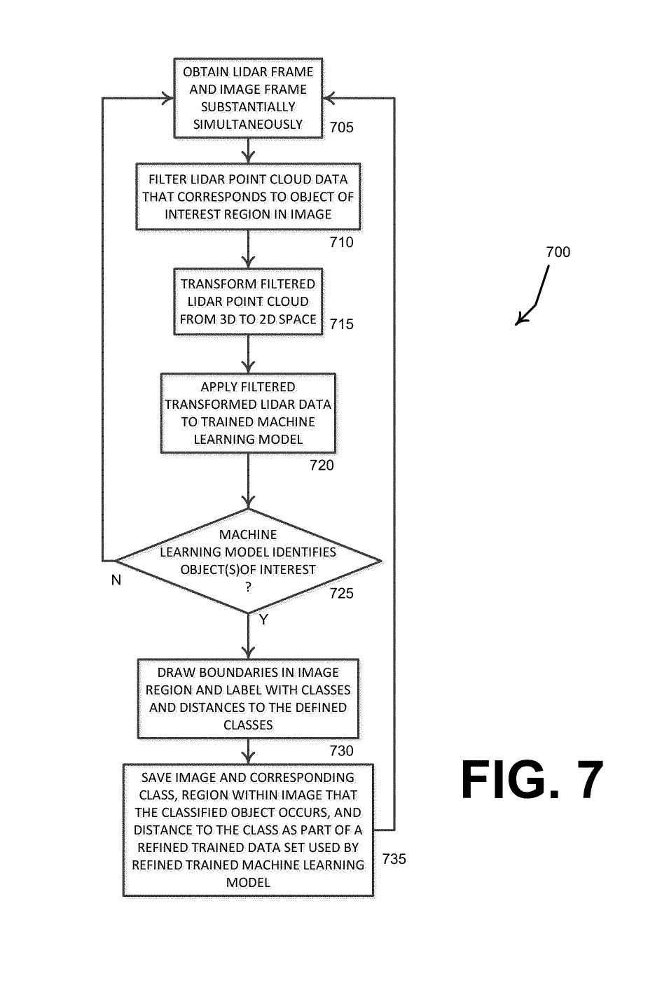

Turning now to FIG. 7, the figure illustrates a method 700 for automatically refining a trained machined learning model. At step 705 a first set of one or more images are obtained from an image sensor, typically part of a camera. The camera may be a still camera or a video camera that captures images at a predetermined frame rate. At substantially the same time as one or more of the images are captured, a LIDAR system pointed generally in a direction that is within the field of view of the camera, captures point cloud data by projecting one or more light burst and determining whether reflections were received back from the light burst projections. Point cloud data corresponding to a still image, or video frame, (i.e., one or more light bursts were projected and the corresponding reflection(s) were received back during a period while the camera was capturing the one or more images) are matched, or paired, with the corresponding image data set (i.e., digital data representations of pixels that compose the one or more images).

At step 710, the LIDAR point cloud data for a given image are filtered, perhaps using a compression method or technique, to isolate reflected light burst data and for mapping with objects represented in the one or more images. The objects in the images may have been previously selected by manual placing of boundaries around one or more objects in the image. Or, the objects may have been automatically identified and selected with boundaries by a trained machine learning model.

At step 715 the filtered LIDAR point cloud data that corresponds to one or more selected objects of interest in an image may be transformed from a three-dimensional space to a two-dimensional space. The two-dimensional point cloud data set is mapped to the corresponding image data. Although transformed into two dimensional space, because LIDAR data includes information regarding how far away an object surface is from the LIDAR system (i.e., depth), the transformed LIDAR data set may also include depth and direction information for the surfaces of objects represented by pixels of the image via mapping of the two-dimensional point cloud data with the pixels on a pixel-by-pixel basis.

At step 720 the filtered and transformed point cloud data and corresponding image information is applied as inputs to a machine learning model. If the machine learning model has been previously trained, the trained machine learning model may evaluate the LIDAR point cloud data to automatically recognize an object based on previous training when the two-dimensional point cloud data matches previous point cloud data that match similar object image data within predetermined criteria/tolerances for parameters, factors, or function of the trained machine learning model. If evaluation at step 725 of the point cloud data results in a determination that the point cloud data under evaluation (captured at step 705) matches previous point cloud data that corresponds to previous image data according to the machine learning model, image data that represents an object-of-interest in the current image under evaluation (captured at step 705) may be automatically bounded in the image without human intervention at step 730. At step 735, object-of-interest image data and corresponding LIDAR point cloud data that represent an object-of-interest in the current image under evaluation are saved and used to revise parameters, functions, and factors of the machine learning model for use in future iterations of method 700. Along with the image data and point cloud data for the determine object of interest, method 700 may save/store metadata information associated with the object, which object metadata information may include object classification, region within the image that the classified object occurs, direction of the object relative to the camera or LIDAR system that captured the image and point cloud data (this may be the same as the location of the object within the image that the object occurs), distance to the object's surface(s), or motion of the object, which may be determined by evaluating multiple images. The object metadata may be stored along with the image data and point cloud data as part of a data set that may be referred to herein as a refined trained data set. After step 735, or if no object is determined to appear in an image under evaluation at step 725, method 700 returns to step 705.

Ultimately, the automatically refined trained machine learning model may be used to determine the nature, bearing/direction of, motion of, or distance to, objects of interest in camera images without using LIDAR data by applying images captured in the future relative to the training and refining of the training, to the refined trained machine learning model. The automatically refined trained machine learning model, and parameters, functions, factors, coefficients, that compose it, may be used by an autonomous vehicle while autonomously navigating along a route. In such a scenario, a controller, interface, device, computer, or application that implements the refined trained machine learning model and processes data from various sensors onboard the autonomous vehicle may be different than a controller, interface, device, computer, or application that performed steps described herein of training a machine learning model into a trained machine learning model and refining the trained machine learning model into a refined trained machine learning model.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. Disclosure of particular hardware is given for purposes of example. In addition to the recitation above in reference to the figures that particular steps may be performed in alternative orders, as a general matter steps recited in the method claims below may be performed in a different order than presented in the claims and still be with the scope of the recited claims.

What is claims is:

1. A method, comprising:
generating a first LIDAR point cloud data set that corresponds to a first image data set, wherein first images from which the first image data set are derived and first LIDAR point clouds corresponding to the first images from which the first LIDAR point cloud data set are derived are captured and generated in temporal synchronicity and directional alignment;
classifying each of one or more objects-of-interest in each of the first images as belonging to a particular classification of objects;
mapping LIDAR point cloud data from the first LIDAR point cloud data set to at least one of the one or more objects-of-interest that correspond to the first LIDAR point cloud data;
applying the mapped object-of-interest LIDAR point cloud data and corresponding first image data to a machine leaning model to train the machine learning model to become a trained machine learning model;
generating a second LIDAR point cloud data set that corresponds to a second image data set, wherein second images from which the second image data set are derived and second LIDAR point clouds, corresponding to the second images, that the second LIDAR point cloud data set are derived from are captured and generated in temporal synchronicity and directional alignment; and
applying the second LIDAR point cloud data set and corresponding second image data set to the trained machine leaning model to automatically, without human intervention, refine the trained machine learning model to become a refined trained machine learning model.

2. The method of claim 1 wherein an object of interest in each of the one or more first images is one of a traffic control sign, a vehicle, an animal, a person, a rock, a tire, a log, a board, a crate, a box, a barrel, a bag, a cone, a barrel, a guardrail, a curb, painted lines, a traffic control light, a pole embedded along a road.

3. The method of claim 1 wherein an image evaluation range manually selected in each of the first images maps to substantially all object-of-interest LIDAR point cloud data that correspond to the object-of-interest in the image.

4. The method of claim 3 wherein an image evaluation range data set includes evaluation range LIDAR point cloud coordinates that correspond to an image that was captured at substantially the same time as the point cloud data was generated.

5. The method of claim 1 further comprising deriving, based on the first or second LIDAR point cloud data set, a distance measurement estimation to an object-of-interest by applying a mathematical function to LIDAR point cloud data that correspond to pixels in an image evaluation range that represent the object-of-interest.

6. The method of claim 1 wherein applying the second LIDAR point cloud data set and corresponding second image data set to the trained machine leaning model to automatically, without human intervention, refine the trained machine learning model to become a refined trained machine learning model includes:
determining, based on the second LIDAR point cloud data set, objects-of-interest in the second images;
deriving, based on the second LIDAR point cloud data set, classification of objects-of-interest in the second images;
mapping LIDAR point cloud data from the second LIDAR point cloud data set to at least one of the one or more objects-of-interest in the second image data set; and
wherein the determined object-of-interest within the second images and corresponding point cloud data are used to train the trained machine learning model to become the refined trained machine learning model.

7. The method of claim 1 wherein the machine learning model is one of: a convolutional neural network, a deep learning algorithm, a neural network, a support vector machine, or a regression function.

8. The method of claim 6 further comprising determining a distance to an object-of-interest in an image using the refined trained machine learning model and without using LIDAR point cloud data.

9. The method of claim 1 wherein a plurality of LIDAR systems are used to obtain LIDAR points clouds that correspond to the first or second images.

10. The method of claim 1 wherein the classifying of each of one or more objects-of-interest in each of the first images as belonging to a particular classification of objects further comprises using a user interface to manually bound each of the one or more objects-of-interest.

11. The method of claim 1 wherein the user interface includes a means for entering meta data associated with a given object-of-interest.

12. The method of claim 11 wherein the meta data is applied to the machine learning model along with the mapped object-of-interest LIDAR point cloud data and corresponding first image data to the machine leaning model to train the machine learning model to become the trained machine learning model.

13. The method of claim 1 wherein the automatically, without human intervention, refining of the trained machine learning model to become the refined trained machine learning model includes automatically bounding each of the one or more objects-of-interest in the second images that correspond to the second image data set.

14. A non-transitory computer readable medium storing computer program instructions defining operations comprising:
generating a first LIDAR point cloud data set that corresponds to a first image data set, wherein first images from which the first image data set are derived and first LIDAR point clouds corresponding to the first images from which the first LIDAR point cloud data set are derived are captured and generated in temporal synchronicity and directional alignment;
classifying each of one or more objects-of-interest in each of the images as belonging to a particular classification of objects;
mapping LIDAR point cloud data from the LIDAR point cloud data set to at least one of the one or more objects-of-interest that correspond to the LIDAR point cloud data;
applying the mapped object-of-interest LIDAR point cloud data and corresponding first image data to a machine leaning model to train the machine learning model to become a trained machine learning model;
generating a second LIDAR point cloud data set that corresponds to a second image data set, wherein second images from which the second image data set are derived and second LIDAR point clouds corresponding to the second images from which the second LIDAR point cloud data set are derived are captured and generated in temporal synchronicity and directional alignment; and
applying the second LIDAR point cloud data set and corresponding second image data to the trained machine leaning model to automatically, without human intervention, refine the trained machine learning model to become a refined trained machine learning model.

15. The non-transitory computer readable medium storing computer program instructions defining operations of claim 14 wherein an object of interest in each of the one or more first images is one of a traffic control sign, a vehicle, an animal, a person, a rock, a tire, a log, a board, a crate, a box, a barrel, a bag, a cone, a barrel, a guardrail, a curb, painted lines, a traffic control light, a pole embedded along a road.

16. The non-transitory computer readable medium storing computer program instructions defining operations of claim 14 wherein an image evaluation range manually selected in each of the first images maps to substantially all object-of-interest LIDAR point cloud data that correspond to the object-of-interest in the image.

17. The non-transitory computer readable medium storing computer program instructions defining operations of claim 16 wherein an image evaluation range data set includes evaluation range LIDAR point cloud coordinates that correspond to an image that was captured at substantially the same time as the point cloud data was generated.

18. The non-transitory computer readable medium storing computer program instructions defining operations of claim 14 further comprising deriving, based on the first or second LIDAR point cloud data set, a distance measurement estimation to an object-of-interest by applying a mathematical function to LIDAR point cloud data that correspond to pixels in an image evaluation range that represent the object-of-interest.

19. A non-transitory computer readable medium storing computer program instructions defining operations comprising:
providing a refined trained machine learning model that was generated according to computer program instructions defining operations comprising:
generating a first LIDAR point cloud data set that corresponds to a first image data set, wherein first images from which the first image data set are derived and first LIDAR point clouds corresponding to the first images from which the first LIDAR point cloud data set are derived are captured and generated in temporal synchronicity and directional alignment;
classifying each of one or more objects-of-interest in each of the images as belonging to a particular classification of objects;
mapping LIDAR point cloud data from the LIDAR point cloud data set to at least one of the one or more objects-of-interest that correspond to the LIDAR point cloud data;
applying the mapped object-of-interest LIDAR point cloud data and corresponding first image data to a machine leaning model to train the machine learning model to become a trained machine learning model;
generating a second LIDAR point cloud data set that corresponds to a second image data set, wherein second images from which the second image data set are derived and second LIDAR point clouds corresponding to the second images from which the second LIDAR point cloud data set are derived are captured and generated in temporal synchronicity and directional alignment; and
applying the second LIDAR point cloud data set and corresponding second image data to the trained machine leaning model to automatically, without human intervention, refine the trained machine learning model to become a refined trained machine learning model;
and
wherein the refined trained machine learning model determines a distance to an object-of-interest in a third image that is not one of the first images or second images without using LIDAR point cloud data that corresponds to the third image.

20. The non-transitory computer readable medium of claim 19 wherein the refined trained machine learning model was generated according to computer program instructions defining operations further comprising:
wherein applying the second LIDAR point cloud data set and corresponding second image data set to the trained machine leaning model to automatically, without human intervention, refine the trained machine learning model to become a refined trained machine learning model includes:
determining, based on the second LIDAR point cloud data set, objects-of-interest in the second images;
deriving, based on the second LIDAR point cloud data set, classification of objects-of-interest in the second images;
mapping LIDAR point cloud data from the second LIDAR point cloud data set to at least one of the one or more objects-of-interest in the second image data set; and
wherein the determined object-of-interest within the second images and corresponding point cloud data are used to train the trained machine learning model to become the refined trained machine learning model.
